(19) United States
(12) Patent Application Publication
(10) Pub. No.: US 2018/0240031 A1
(43) Pub. Date: Aug. 23, 2018

(54) ACTIVE LEARNING SYSTEM

(71) Applicant: Twitter, Inc., San Francisco, CA (US)

(72) Inventors: Ferenc Huszar, Cambridge (GB); Pietro Berkes, London (GB); Zehan Wang, London (GB)

(21) Appl. No.: 15/876,906

(22) Filed: Jan. 22, 2018

Related U.S. Application Data
(60) Provisional application No. 62/460,459, filed on Feb. 17, 2017.

(51) Int. Cl. G06N 7/00; G06F 9/4401; G06N 99/00

(52) U.S. Cl. CPC G06N 7/005; G06N 99/005; G06F 9/4416

(57) ABSTRACT

Systems and methods provide a deep neural network trained via active learning. An example method includes generating, from a set of labeled objects, a plurality of differing training sets, assigning each of the plurality of training sets to a respective deep neural network in a committee of networks, and initializing each of the deep neural networks in the committee by training the deep neural network using the respective assigned training set. The method further includes iteratively training the deep neural networks in the committee until convergence and using one of the deep neural networks to make predictions for unlabeled objects. The training may include identifying unlabeled objects with highest diversity in predictions from the plurality of deep neural networks, obtaining a respective label for each identified unlabeled object, and retraining the deep neural networks with the respective labels for the objects.

### RELATED APPLICATION

This application is a non-provisional of, and claims priority to, U.S. Provisional Application No. 62/460,459, filed on Feb. 17, 2017, titled “Active Learning System,” the disclosure of which is incorporated herein in its entirety.

### BACKGROUND

Machine learning is the field of study where a computer or computers learn to perform classes of tasks using the feedback generated from the experience or data that the machine learning process acquires during computer performance of those tasks. Typically, machine learning can be broadly classed as supervised and unsupervised approaches, although there are particular approaches such as reinforcement learning and semi-supervised learning that have special rules, techniques and/or approaches.

Supervised machine learning relates to a computer learning one or more rules or functions to map between example inputs and desired outputs as predetermined by an operator or programmer, usually where a data set containing the inputs is labelled. Supervised machine learning techniques require labeled data points. For example, to learn a classifier that classifies images, the classifier needs to be trained on a set of correctly classified images. Typically, these labels are costly to obtain, because they need human expert input, or, in other words, human raters. Unsupervised learning relates to determining a structure for input data, for example, when performing pattern recognition, and typically uses unlabeled data sets. Reinforcement learning relates to enabling a computer or computers to interact with a dynamic environment, for example, when playing a game or driving a vehicle. Various hybrids of these categories are possible, such as “semi-supervised” machine learning, in which a training data set has been labelled only partially.

For unsupervised machine learning, there is a range of possible applications such as, for example, the application of computer vision techniques to image processing or video enhancement. Unsupervised machine learning is typically applied to solve problems where an unknown data structure might be present in the input data. As the data is unlabeled, the machine learning process identifies implicit relationships between the data, for example, by deriving a clustering metric based on internally derived information. For example, an unsupervised learning technique can be used to reduce the dimensionality of a data set and to attempt to identify and model relationships between clusters in the data set, and can, for example, generate measures of cluster membership or identify hubs or nodes in or between clusters (for example, using a technique referred to as weighted correlation network analysis, which can be applied to high-dimensional data sets, or using k-means clustering to cluster data by a measure of the Euclidean distance between each datum).

Semi-supervised learning is typically applied to solve problems where there is a partially labelled data set, for example, where only a subset of the data is labelled. Semi-supervised machine learning makes use of externally provided labels and objective functions as well as any implicit data relationships. Active learning is a special case of semi-supervised learning, in which the system queries a user or users to obtain additional data points and uses unlabeled data points to determine which additional data points to provide to the user for labeling.

When initially configuring a machine learning system, particularly when using a supervised machine learning approach, the machine learning algorithm can be provided with some training data or a set of training examples, in which each example is typically a pair of an input signal/vector and a desired output value, label (or classification) or signal. The machine learning algorithm analyses the training data and produces a generalized function that can be used with unseen data sets to produce desired output values or signals for the unseen input vectors/signals.

The use of unsupervised or semi-supervised machine learning approaches are sometimes used when labelled data is not readily available, or where the system generates new labelled data from unknown data given some initial seed labels.

Deep learning techniques, e.g., those that use a deep neural network for the machine learning system, differ from conventional neural networks and support vector machines (SVMs) in that deep learning increases the number of hidden layers and can better model non-linear complexities within the data. Because of this, deep learning works best when the number of training examples is large, e.g., millions or tens of millions, making supervised training of a deep learning classifier impractical. Current training approaches for most machine learning algorithms can take significant periods of time, which delays the utility of machine learning approaches and also prevents the use of machine learning techniques in a wider field of potential application.

### SUMMARY

Implementations provide an active learning system for training a deep learning system, e.g., a deep neural network classifier. Techniques enable the deep neural network to be trained with a small set of labeled training data and to be trained faster. The active learning system uses Bayesian bootstrapping to train a committee of deep neural networks, which are used to find additional data objects for labeling from a very large set of unlabeled data objects. The additional data objects identified by the committee are informative objects. Informative objects are identified based on diversity in the predictions of the committee members. Once labeled by human raters, the informative objects are used to further train the committee members, which can then find additional informative data objects. Eventually the committee members reach a consensus and the trained model can be provided for use in classifying unlabeled objects. Active learning using query-by-committee has been used to train small neural networks on simple tasks, but has not been applied to massively over-parametrized modern deep neural network architectures. This is because the parameter-space of small neural networks are simpler, lower dimensional, so initializing the committee members can be accomplished by various methods of approximate Bayesian inference which do not work well in the large modern deep networks. In Bayesian inference, the answer to a machine learning problem is not just a single deep learning model, but a whole distribution of deep learning models, called the posterior distribution. For query-by-committee to work, the committee members should represent independent samples from the posterior. Modern deep learning uses optimization techniques to find a single local minimum using a variant of stochastic gradient descent: this results in a point estimate rather than a posterior distribution. Approximating the posterior of deep neural networks is difficult because of the large number of parameters (e.g., millions or billions). Variational inference techniques approximate the posterior by a simple approximate posterior distribution, often an uncorrelated Gaussian, which cannot capture the full complexity of the posterior as required for active learning. Furthermore, implementing variational inference in deep learning requires significant changes to the algorithms used to train the neural networks, and such change may not be practical for consideration in production environments. Markov chain Monte Carlo (MCMC) techniques can approximate the posterior more flexibly by producing a sequence of correlated samples from the posterior. However, MCMC methods are less efficient in large networks due to the complex nonlinear dependencies and redundancies in the network's parameters. Additionally, it is more difficult to analyze the convergence of MCMC methods compared to stochastic gradient descent which makes these methods less practical in production systems. In summary, information theoretic active learning has not been used to train deep neural networks because it was not known how to obtain deep neural network committee members that represent the Bayesian posterior accurately, in a way that requires minimal changes to the training algorithms deployed in production environments. Disclosed implementations provide such a method, i.e., a way to obtain deep neural network committee members that represent the Bayesian posterior accurately with minimal changes to the training algorithms deployed in production environments.

In one aspect, a method includes initializing committee members in a committee, each committee member being a deep neural network trained on a different set of labeled objects, i.e., labeled training data. The method also includes providing an unlabeled object as input to each of the committee members and obtaining a prediction from each committee member. The prediction can be a classification, a score, etc. The method includes determining whether the various predictions satisfy a diversity metric. Satisfying the diversity metric means that the predictions represent a data object for which the parameters under the posterior disagree about the outcome the most. In some implementations the diversity metric is a Bayesian Active Learning by Disagreement (BALD) score. An unlabeled data object that satisfies the diversity metric is an informative object. The method may include identifying several informative objects. The method may further include providing the informative objects to human raters, who provide information used to label the informative objects. The method includes re-training the committee members with the newly labeled data objects. The method may include repeating the identification of informative objects, labeling of informative objects, and re-training the committee members until the committee members reach convergence. In other words, eventually the committee members may agree enough that very few, if any, unlabeled data objects result in predictions that satisfy the diversity metric. Any one of the trained committee members may then be used in labeling additional data objects.

In another aspect, a computer program product embodied on a computer-readable storage device includes instructions that, when executed by at least one processor formed in a substrate, cause a computing device to perform any of the disclosed methods, operations, or processes disclosed herein.

One or more of the implementations of the subject matter described herein can be implemented so as to realize one or more of the following advantages. As one example, the system learns a strong machine learning model from a much smaller set of labelled examples than is conventionally used to train a system. For example, rather than using tens of millions of labeled data points, i.e., labeled objects, to train a strong model, the system can train the model with under ten thousand labeled data points, many of those identified during the training.

The details of one or more implementations are set forth in the accompanying drawings and the description below. Other features will be apparent from the description and drawings, and from the claims.

### BRIEF DESCRIPTION OF THE DRAWINGS

FIG. 1 illustrates an example system in accordance with the disclosed subject matter.

FIG. 2 illustrates a flow diagram of an example active learning process, in accordance with disclosed subject matter.

FIG. 3 illustrates a flow diagram of an example process for initializing a plurality of committee members for an active learning process, in accordance with disclosed subject matter.

FIG. 4 shows an example of a distributed computer device that can be used to implement the described techniques.

FIG. 5 illustrates a flow diagram of an example process for initializing a plurality of committee members for an active learning process, in accordance with disclosed subject matter.

Like reference symbols in the various drawings indicate like elements.

### DETAILED DESCRIPTION

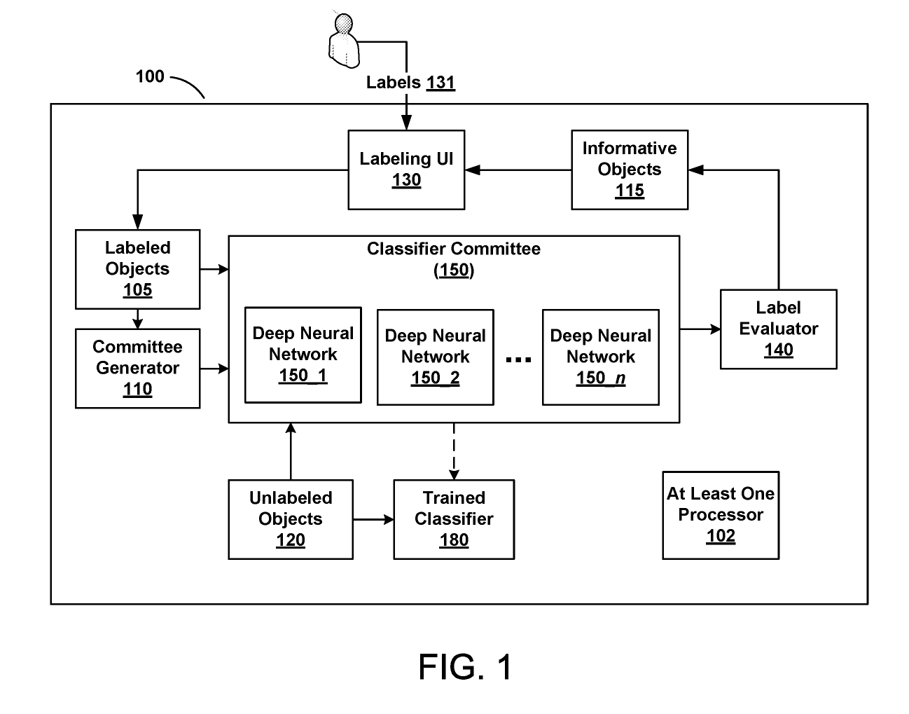

FIG. 1 is a block diagram of an active learning system 100 in accordance with an example implementation. The system 100 may be used to build a highly accurate classifier or other machine learning system in less time and with greatly reduced number of labeled examples. Because the systems and methods described result in a trained classifier (or other type of predictive model) with minimized input from a human user, the systems and methods are scalable and can be used to build deep neural classifiers where unsupervised learning is inapplicable or unavailable. For example, human-qualitative judgments/classifications cannot be determined by analysis of unlabeled data alone. Thus, deep learning systems have not previously been trained to output such judgments. For ease of discussion, the depiction of system 100 in FIG. 1 is described as a system for generating a classifier, which is one type of machine learning system. However, other configurations and applications may be used. For example, the machine learning system may predict a score for the input data, e.g. similarity score, quality score, or may provide any other decision, depending on how the training data is labeled.

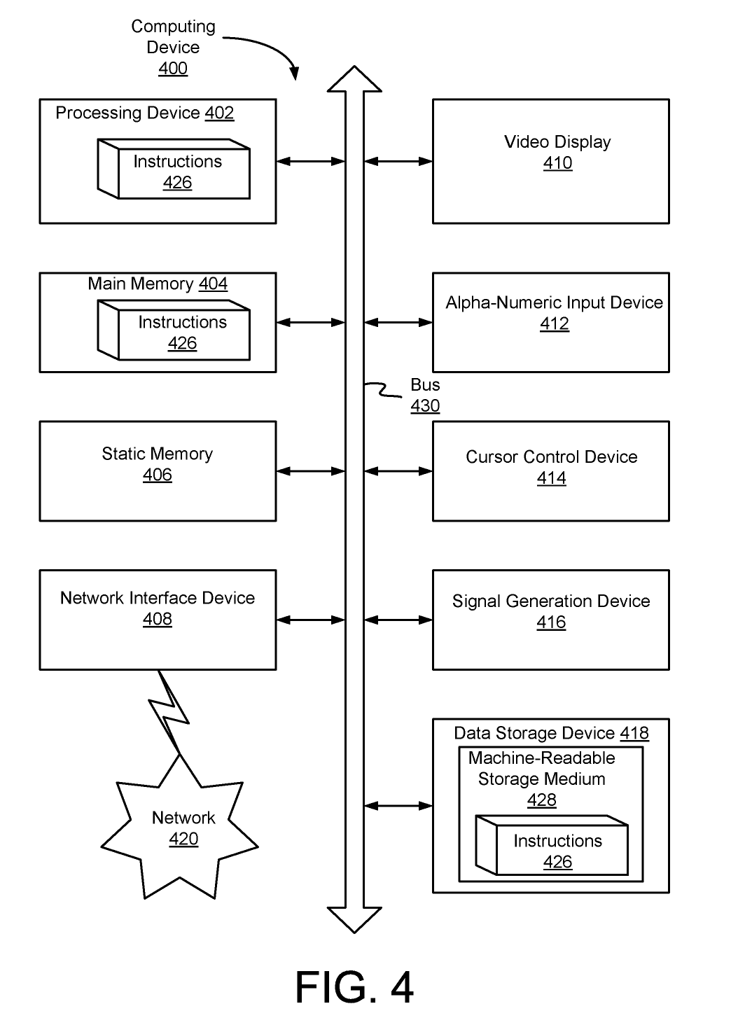

The active learning system 100 may be a computing device or devices that take the form of a number of different devices, for example, a standard server, a group of such servers, or a rack server system. In addition, system 100 may be implemented in a personal computer, for example, a laptop computer. The active learning system 100 may be an example of computer device 400, as depicted in FIG. 4.

The active learning system 100 can include one or more processors 102 formed in a substrate configured to execute one or more machine executable instructions or pieces of software, firmware, or a combination thereof. The processors 102 can be semiconductor-based—that is, the processors can include semiconductor material that can perform digital logic. The active learning system 100 can also include an operating system and one or more computer memories, for example, a main memory, configured to store one or more pieces of data, either temporarily, permanently, semi-permanently, or a combination thereof. The memory may include any type of storage device that stores information in a format that can be read and/or executed by the one or more processors. The memory may include volatile memory, non-volatile memory, or a combination thereof, and store modules that, when executed by the one or more processors, perform certain operations. In some implementations, the modules may be stored in an external storage device and loaded into the memory of system 100.

The active learning system 100 includes labeled objects 105. Labeled objects 105 may be stored in a memory. In some implementations, the labeled object 105 may be stored in a memory remote from, but accessible (e.g., via a network) to, the system 100. Labeled objects 105 represent input data points for the deep neural networks that make up the members of the classifier committee. The labeled objects may have been labeled by human raters. The labeled objects 105 can include positive training examples. Positive training examples are data points that tell the deep neural network that the input data object should result in the classification (or score, or other decision) that the human rater has provided. The labeled objects 105 can include negative training examples. A negative training example is a data point that tells the deep neural network that the input data object should not be given the classifier (or score or other decision) that the human rater has provided. The data objects themselves can be any input data, e.g., digital files or records. In some implementations, the data object may be a feature vector describing an underlying object. A feature vector is an array of numbers, typically floating point numbers, where each position in the array represents a different attribute or signal about the object. Thus, for example, if the object is an image file, the feature vector may represent different attributes about the image file. A labeled object may also represent two underlying objects, e.g., a first object and a second object, and the label may represent a conclusion about the objects, e.g., how similar a human rater thinks the objects are, whether one image is better than the second image, etc. For example, a labeled object may be one feature vector for an image and another feature vector for another image where the label represents some comparison between the two images (e.g., how similar, same classification, quality score, etc.) Reference to an object as used herein can refer to the original object (a file, a record, an image, a document, etc.) or a feature vector, or some other signal or data point that represents that object. Similarly, reference to a labeled object as used herein may refer to one or more objects that have been given a label by a human rater or by a machine learning system configured to generate the labels using known or later discovered techniques.

The active learning system 100 also includes unlabeled objects 120. Unlabeled objects 120 may be stored in a memory of the system 100. Unlabeled objects 120 may also be stored in a memory remote from, but accessible to the system 100. The objects in the unlabeled objects 120 are far more numerous (e.g., by orders of magnitude) than the objects in labeled objects 105. The unlabeled object 120 have the same format or structure as the labeled objects 105, but lack a corresponding label. The objects in the unlabeled objects 120 may be dynamic. In other words, the objects in the unlabeled objects 120 may change frequently, with new objects being added, other objects changing, and objects being deleted. Thus, there can be a constant supply of unlabeled objects 120 that have not been used to train the committee members 150 or that need classification using the trained classifier 180.

The active learning system 100 also includes a classifier committee 150 that includes a plurality of committee members. Each committee member is a deep neural network, e.g. deep neural network 150_1, deep neural network 150_2, through deep neural network 150_n where n represents any integer greater than 1. As each committee member consumes additional computational resources, there is a trade-off between resource consumption and gains from adding additional committee members. The value of n is dependent on the application of the classifier and practical considerations/available resources. The committee members together represent an approximation to the Bayesian posterior. Active learning in small networks could rely on a number of approximate inference techniques—variational inference of MCMC—that work well for small dimensional problems but may not be as appropriate in very large deep networks used today.

Rather than using variational inference or MCMC, the active learning system 100 approximates the Bayesian posterior using techniques which require fewer changes to existing deep learning systems. In some implementations, the active learning system 100 approximates the Bayesian posterior via Bayesian bootstrapping. In such implementations, the modules in the active learning system 100 include a committee generator 110. The committee generator 110 may generate different training sets of data from the labeled objects 105. Each training set is differently subsampled and/or reweighed from the labeled objects 105. For example, if the labeled objects 105 includes five labeled objects, the committee generator 110 may generate a first training set with only three of the five labeled objects, a second training set with four of the five labeled objects, but with a first labeled object given a higher weight than the rest (so that the deep neural network puts greater emphasis on this example), and generate a third training set with all five objects, but with each training example given a different weight, etc. This technique is known as Bayesian bootstrapping, and was first described by Rubin in “The Bayesian Bootstrap,” (1981) available at https://projecteuclid.org/euclid.aos/1176345338. While Bayesian bootstrapping has been used in other problems, it has not been used with deep neural networks, especially for active learning, where the network includes hundreds of thousands if not millions of parameters. In the active learning system 100 the committee generator 110 initializes each committee member by training it using one of the different training sets generated by the committee generator 110. For training of each committee member the system can use any algorithm for training a deep neural network, without modification. Because each training set is different from the other training sets, each deep neural network (i.e., each committee member) is initially trained with different data. This means that each committee member makes different mistakes in the output provided, e.g., prediction, classification, judgment, score, etc., but the mistakes made by the different members represent the uncertainty about the prediction given the full training dataset provided. These differences can be quantified and are exploited in the active learning system.

As another alternative for approximating the Bayesian posterior, in some implementations, the committee generator 110 may train a single deep neural network on the labeled objects 105. For ease of explanation, this single neural network may be referred to as the source neural network. The source network at this point has some optimal parameters, which can be represented as θ*={θ*₁, θ*₂, . . . θ*ᵢ} where i indexes the parameters (e.g., thousands or millions of such parameters). From the source neural network, the committee generator 110 may estimate the empirical Fisher information matrix or an approximation thereof. For example, the committee generator 110 may estimate the diagonal entries of the Fisher information matrix from first-order gradients. This will result in a Fisher information value Fi for each parameter θ*ᵢ. Estimating diagonal entries of the Fisher information matrix is a known method accomplished using a method similar to back propagation, and requires minimal change to the algorithms already used to train the source network. Using the Fisher information matrix and the source neural network weights, the committee generator 110 may draw random neural network samples with randomized parameters. Each random neural network sample is one of the committee members of the committee 150. In some implementations, the committee generator 110 may draw parameters from a Gaussian distribution with a mean at θ*ᵢ and precision proportional to Fᵢ. Drawing random samples from the source network results in committee members with noisy versions of the source network but the noise has the structure of the Fisher information matrix. The method may be referred to as a Laplace approximation.

The modules in the active learning system 100 also include a label evaluator 140. After the committee members in the classifier committee 150 have been initialized, the label evaluator 140 is configured to receive the output of the various committee members in the classifier committee 150 for a specific unlabeled object, e.g., from unlabeled objects 120. For example, after initialization, the system 100 may provide a large number of unlabeled objects 120 to the committee members in the classifier committee 150. Each committee member provides an output, e.g., a predicted classification, for each unlabeled object. The label evaluator 140 may evaluate the diversity of the predictions to determine whether the predictions for the unlabeled object satisfy a diversity metric. The diversity metric measures how much variance exists in the predictions. In some implementations, any unlabeled objects that meet some threshold satisfy the diversity metric. In some implementations, some quantity of unlabeled objects having the highest diversity satisfy the diversity metric. In some implementations, the diversity metric may represent the predictions for which the parameters under the posterior disagree about the outcome the most. In some implementations, the label evaluator 140 may use a Bayesian Active Learning by Disagreement (BALD) criteria as the diversity metric. The BALD criteria is described by Houlsby et al. in “Bayesian Active Learning for Classification and Preference Learning,” (2011), available at https://pdfs.semanticscholar.org/7486/e148260329785fb347ac6725bd4123d8dad6.pdf. The BALD criterion aims at maximizing the mutual information between the newly acquired labelled example and the parameters of the neural network. This mutual information can be equivalently computed in terms of the average Kullback-Leibler divergence between the probabilistic predictions made by each member of a committee and the average prediction. For binary classification tasks, this KL divergence can be computed analytically provided a committee of neural networks has been produced. In some implementations, the system may use a maximum entropy search as the diversity metric. With maximum entropy search, the system selects the example the average model is most uncertain about. This is known to be inferior to the BALD criterion, but requires fewer committee members, in the extreme case even a single neural network can be used. In some implementations, the system may use binary voting-based criteria for the diversity metric. For example, the system may determine a ratio of positive and negative labels for each unlabeled object. The ratio may represent the diversity metric, with a ratio close to one being the most diverse.

The label evaluator 140 may identify any unlabeled objects that satisfy the diversity metric as informative objects 115. Identification can be accomplished in any manner, such as setting a flag or attribute for the unlabeled object, saving the unlabeled object or an identifier for the unlabeled object in a data store, etc.

The modules in the active learning system 100 may also include a labeling user interface (UI) 130. The labeling user interface may be configured to present information about one or more informative objects 115 to a human rater, who provides a label 131 for the informative object. In some implementations, the labeling UI 130 may be used to obtain the labels for the objects used to initialize the deep neural networks. In some implementations, the labeling UI 130 may provide the same informative object 115 to several human raters and receive several potential labels for the informative object. The system 100 may aggregate the potential labels in some manner, e.g., majority vote, averaging, dropping low and high and then averaging, etc., to generate the label 131 for the object. Once the informative object receives a label 131, it can be stored in labeled objects 105 and used to retrain the committee members in the classifier committee 150. In other words, the system 100 may undergo an iterative training process, where newly labeled objects are provided for further training, unlabeled objects are provided to the re-trained classifier committee, additional informative objects are identified, labeled, and then used to retrain the committee members. In some implementations, retraining committee members may involve updating or resampling the datasets created by the committee generator 110 with the newly acquired labeled examples, and then continuing to train the committee members on these updated datasets starting from the previous parameter values. In some implementations, the committee members' parameters may be reset to random values before retraining. In some implementations, online learning may be applied whereby we retrain committee members on newly acquired labelled examples only. In other words, the committees may be initialized by updating the Bayesian bootstrap or Laplace approximation described herein. These iterations can occur for a number or rounds or until the deep neural networks converge. In other words, after several rounds of re-training there may not be sufficient diversity in the output of the committee members. This indicates that any of the deep neural networks, e.g., 150_1 to 150_n, can be used as a trained classifier 180. In some implementations, the system may use the BALD criterion to analyze how much more is there to gain from any new example to be labeled. For example, the system may evaluate BALD on each of a universe of unlabeled objects and determine the maximum BALD. The maximal BALD score on the outstanding unlabeled objects should decrease over time. Accordingly, the system may monitor the BALD score of the items selected by active learning and terminate the iterations when this falls below a certain value. In some implementations, the system may monitor the performance of the models in parallel on some held-out validation or test objects, and stop when performance on the validation or test objects reaches a satisfactory value.

Although not illustrated in FIG. 1, active learning system 100 may be in communication with client(s) over a network. The clients may enable a human rater to provide the label 131 via the labeling UI 130 to the active learning system 100. Clients may also allow an administrator to provide parameters to the active learning system 100. Clients may also allow an administrator to control timing, e.g., to start another round of retraining after human raters have provided labels for some or all of the outstanding informative objects 115, or to start a round of inference, where committee members provide output and the system identifies additional informative objects. Clients may also enable an administrator to provide additional locations of unlabeled objects 120. The network may be for example, the Internet or the network can be a wired or wireless local area network (LAN), wide area network (WAN), etc., implemented using, for example, gateway devices, bridges, switches, and/or so forth. In some implementations, active learning system 100 may be in communication with or include other computing devices that provide updates to the unlabeled objects 120 or to labeled objects 105. In some implementations, active learning system 100 may be in communication with or include other computing devices that store one or more of the objects, e.g., labeled objects 105, unlabeled objects 120, or informative objects 115. Active learning system 100 represents one example configuration and other configurations are possible. In addition, components of system 100 may be combined or distributed in a manner differently than illustrated. For example, in some implementations one or more of the committee generator 110, the label evaluator 140, and the labeling UI 130 may be combined into a single module or engine. In addition, components or features of the committee generator 110, the label evaluator 140, and the labeling UI 130 may be distributed between two or more modules or engines.

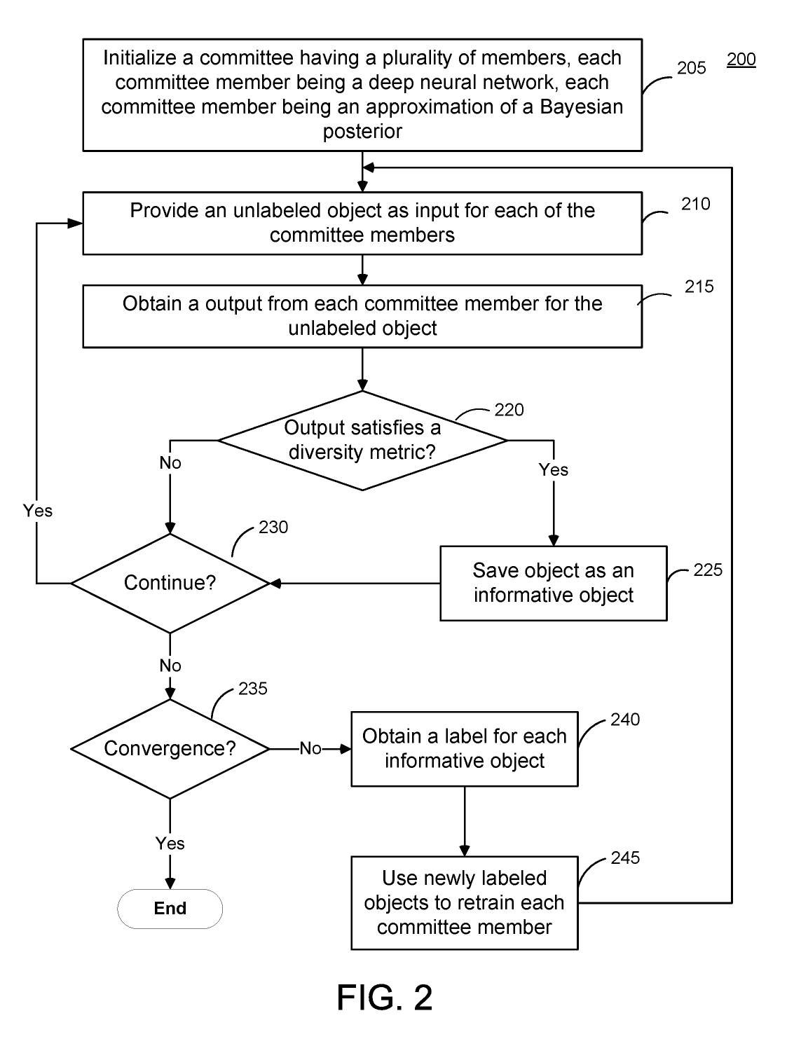

FIG. 2 illustrates a flow diagram of an example active learning process 200, in accordance with disclosed subject matter. Process 200 may be performed by an active learning system, such as system 100 of FIG. 1. Process 200 may begin with the active learning system initializing a committee having a plurality of committee members (205). Each of the committee members is a deep neural network. In some implementations, each of the committee members is trained on a different set of labeled objects. The sets may be determined using Bayesian bootstrapping. The labeled objects can be any input appropriate for training a deep neural network. The number of committee members may be large, e.g., 100 or more. In some implementations, each of the committee members is sampled from a network trained on the set of labeled objects. The sampling may be based on a Fisher information matrix. For example, in the network trained on the set of labeled objects, each parameter may have a respective Fisher information value Fᵢ and the committee members may be sampled by drawing parameters from a Gaussian distribution with a mean at some optimal parameters and variance Fᵢ. Once the committee is initialized, the active learning system may perform iterative rounds of training. A round of training includes identifying informative objects, by evaluating unlabeled objects via the committee and identifying objects with divergent output, obtaining labels for the informative objects, and re-training the committee members with the newly labeled data. Accordingly, the active learning system may provide an unlabeled object as input to each of the committee members (210). Each committee member provides output, e.g., a classification, prediction, etc. (215).

The active learning system determines whether the output from the various committee members satisfies a diversity metric (220). The diversity metric measures how much variance exists in the output for that object. High variance indicates the unlabeled object is informative. In other words, the committee members are not good at successfully predicting the output for this item and having a human rater label the item will help the deep neural networks learn the proper output quickly. In some implementations, BALD criteria is used to determine whether the output satisfies the diversity metric. In some implementations, if the variance in the output for the unlabeled object meets or exceeds a variance threshold, the output satisfies the diversity metric. In some implementations, if the unlabeled object is among some quantity of objects with the highest diversity, the output satisfies the diversity metric. In other words, for each iteration the number of informative objects may be bounded by the quantity.

If the output satisfies the diversity metric (220, Yes), the system saves or flags the unlabeled object as an informative object (225). The system may repeat steps 210-225 with a number of different unlabeled objects (230, Yes). The number may represent the entirety of the objects in an unlabeled data repository (e.g., unlabeled objects 120 of FIG. 1) or a subset of the objects in the unlabeled data repository. In some implementations, the system may select a subset of unlabeled objects with data points that have the potential to unlock additional knowledge. Once the system has run some quantity of unlabeled objects through the committee (230, No), the system may determine whether there is convergence or not (235). In some implementations, convergence may be reached because the system has performed a predetermined number of iterations of steps 210 to 245. In some implementations, convergence may be reached based on the number of informative objects identified. For example, if no informative objects are identified in the most recent iteration, the system may have reached convergence. As another example, convergence may be reached when only a few (less than some quantity) of informative objects are identified in the most recent iteration. As another example, convergence may be reached when the divergence represented by the informative objects fails to meet a diversity threshold.

If convergence is not reached (235, No), the system may obtain a label from a human rater for each informative object identified in the iteration (240). The human rater may provide a label via a user interface that presents information about the informative object to the rater, who then provides the proper label. In some implementations, the information about a given informative object may be presented to several human raters and the system may aggregate the labels in some manner (e.g., voting, averaging, weighted averaging, standard deviation, etc.) The labeling of informative objects may occur over several days. When labels are obtained, the system may provide the newly labeled objects to re-train each committee member (245). In some implementations, retraining may include performing step 205 again. After retraining, the system may then start another iteration to determine whether convergence is reached. Once convergence is reached (235, Yes), process 200 ends. At this point the active learning system has learned a strong model, which can be represented by any one of the committee members.

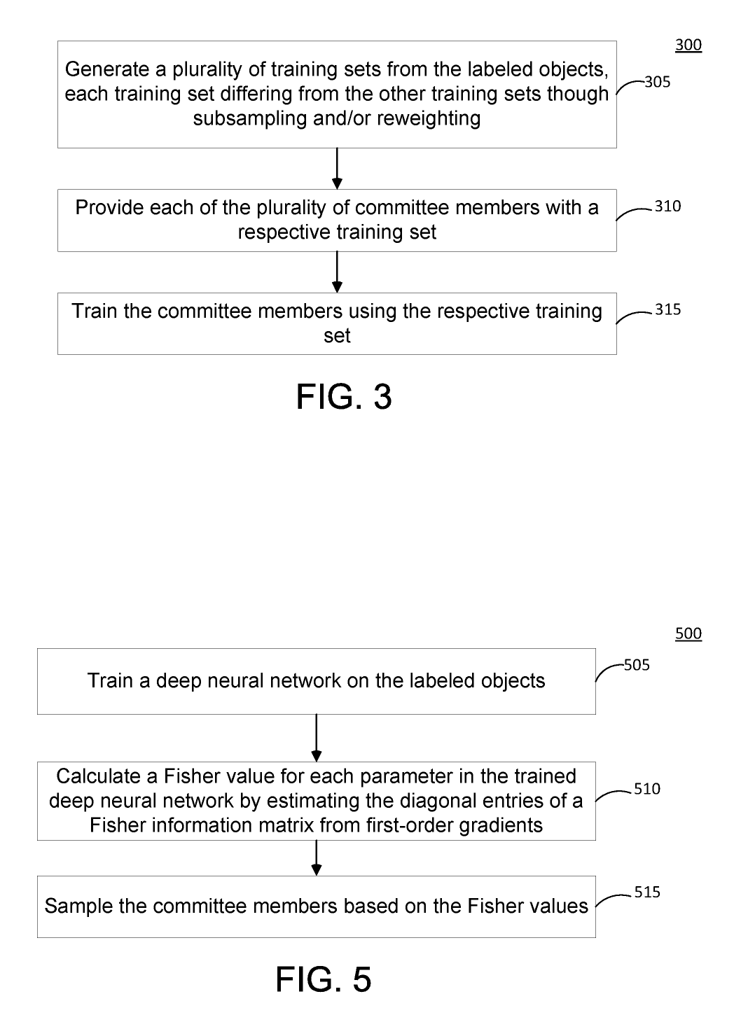

FIG. 3 illustrates a flow diagram of an example process 300 for initializing a plurality of committee members for an active learning process, in accordance with disclosed subject matter. Process 300 may be performed by an active learning system, such as system 100 of FIG. 1, as part of step 205 of FIG. 2. In some implementations, process 300 may also be used to retrain the committee members, e.g., between iterations. Process 300 may begin with the active learning system generating a plurality of training sets from a set of labeled objects (305). Each of the plurality of training sets differs from the other training sets in the plurality of training sets. The differences in the training sets may be due to subsampling. For example, the system may assign an object from the set of labeled objects to a training set based on a function. The differences in the training sets may be due to reweighting. For example, a training set may upweight or downweight a labeled object from the set of labeled objects, so that the deep neural network gives that labeled object more weight (upweight) or less weight (downweight) during initialization. In such an implementation the training sets differ in weights but not necessarily in labeled objects. The differences may be due to a combination of subsampling and reweighting. The subsampling may be randomized. The reweighting may be randomized. In some implementations, the training sets may be generated via Bayesian bootstrapping.

The system may provide each committee member with a respective training set (310). Thus, no two committee members receive the same training set. This means that once initialized the committee members will make different errors in the output, but that the errors are randomized. The system may then train the committee members using their respective training set (315). Once the training is completed, process 300 ends and the system has initialized the committee. The committee members may be used to identify additional objects for labeling, i.e., informative objects, and may be re-trained on labeled informative objects, as discussed with regard to the iterative training of the committee members in FIG. 2.

FIG. 5 illustrates a flow diagram of an example process 500 for initializing a plurality of committee members for an active learning process, in accordance with disclosed subject matter. Process 500 may be performed by an active learning system, such as system 100 of FIG. 1, as part of step 205 of FIG. 2. In some implementations, process 300 may also be used to retrain the committee members, e.g., between iterations. Process 500 may begin with the active learning system training a deep neural network on a set of labeled objects until convergence (505). The training results in some optimal parameters, represented as θ*ᵢ where i indexes the parameters of the network.

The system may calculate a Fisher information value for each parameter (310). For example, the system may generate a Fisher information matrix from first-order gradients and estimate the diagonal entries. For each parameter, this estimation results in the Fisher information value for the parameter. The system may sample the committee members based on the optimal parameters and the Fisher information values (315). For example, the system may sample committee members by drawing parameters from a Gaussian distribution. The Gaussian distribution may have a mean at θ*ᵢ and variance Fᵢ. Each committee member thus sampled represents a noisy version of the originally trained network but the noise is structured by the Fisher information matrix. This also results in committee members that will make different errors in the output. Once sampled, process 500 ends and the system has initialized the committee. The committee members may be used to identify additional objects for labeling, i.e., informative objects, and may be re-trained on labeled informative objects, as discussed with regard to the iterative training of the committee members in FIG. 2.

FIG. 4 illustrates a diagrammatic representation of a machine in the example form of a computing device 400 within which a set of instructions, for causing the machine to perform any one or more of the methodologies discussed herein, may be executed. The computing device 400 may be a mobile phone, a smartphone, a netbook computer, a rackmount server, a router computer, a server computer, a personal computer, a mainframe computer, a laptop computer, a tablet computer, a desktop computer etc., within which a set of instructions, for causing the machine to perform any one or more of the methodologies discussed herein, may be executed. In one implementation, the computing device 400 may present an overlay UI to a user (as discussed above). In alternative implementations, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing device 400 includes a processing device (e.g., a processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 418, which communicate with each other via a bus 430.

Processing device 402 represents one or more general-purpose processing devices such as a microprocessor, central processing unit, or the like. More particularly, the processing device 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also be one or more special-purpose processing devices such as an application specific integrated circuit (ASIC), a field programmable gate array (FPGA), a digital signal processor (DSP), network processor, or the like. The processing device 402 is configured to execute instructions 426 (e.g., instructions for an application ranking system) for performing the operations and steps discussed herein.

The computing device 400 may further include a network interface device 408 which may communicate with a network 420. The computing device 400 also may include a video display unit 410 (e.g., a liquid crystal display (LCD) or a cathode ray tube (CRT)), an alphanumeric input device 412 (e.g., a keyboard), a cursor control device 414 (e.g., a mouse) and a signal generation device 416 (e.g., a speaker). In one implementation, the video display unit 410, the alphanumeric input device 412, and the cursor control device 414 may be combined into a single component or device (e.g., an LCD touch screen).

The data storage device 418 may include a computer-readable storage medium 428 on which is stored one or more sets of instructions 426 (e.g., instructions for the application ranking system) embodying any one or more of the methodologies or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over a network 420 via the network interface device 408.

While the computer-readable storage medium 428 is shown in an example implementation to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media and magnetic media. The term “computer-readable storage medium” does not include transitory signals.

In the above description, numerous details are set forth. It will be apparent, however, to one of ordinary skill in the art having the benefit of this disclosure, that implementations of the disclosure may be practiced without these specific details. Moreover, implementations are not limited to the exact order of some operations, and it is understood that some operations shown as two steps may be combined and some operations shown as one step may be split. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying,” “determining,” “calculating,” “updating,” “transmitting,” “receiving,” “generating,” “changing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

According to one aspect, a method includes providing an unlabeled object as input to each of a plurality of deep neural networks, obtaining a plurality of predictions for the unlabeled object, each prediction being obtained from one of the plurality of deep neural networks, determining whether the plurality of predictions satisfy a diversity metric, and identifying the unlabeled object as an informative object when the predictions satisfy the diversity metric.

These and other aspects can include one or more of the following features. For example, the method may also include providing the informative object to a human rater, receiving a label for the informative object from the human rater, and retraining the plurality of deep neural networks using the label as a positive example for the informative object. As another example, the method may also include initializing the plurality of deep neural networks using Bayesian bootstrapping. As another example, the method may also include initializing the plurality of deep neural networks using a Laplace approximation. As another example, the steps of providing, obtaining, determining, and identifying may be iterated until convergence is reached. In such implementations, convergence may be reached after a predetermined number of iterations, when diversity in the predictions of the deep neural networks fails to meet a diversity threshold, and/or when no unlabeled objects have a plurality of predictions that satisfy the diversity metric. As another example, determining whether the plurality of predictions satisfies the diversity metric may include using Bayesian Active Learning by Disagreement.

According to one aspect, a computer-readable medium stores a deep neural network. The deep neural network is trained by initializing a committee of deep neural networks using different sets of labeled training objects, iteratively training the deep neural networks of the committee until convergence, and storing one of the deep neural networks on the computer readable medium. Iteratively training the deep neural networks of the committee until convergence includes identifying a plurality of informative objects, by providing unlabeled objects to the committee and selecting the unlabeled objects with highest diversity in the predictions of the deep neural networks in the committee, obtaining labels for the informative objects, and retraining the deep neural networks in the committee using the labels for the informative objects.

These and other aspects can include one or more of the following features. For example, convergence may be reached after a predetermined number of iterations, when diversity in the predictions of the deep neural networks fails to meet a diversity threshold, and/or when no unlabeled objects have a plurality of predictions that satisfy the diversity metric. As another example, highest diversity may be measured using Bayesian Active Learning by Disagreement (BALD) criteria. As another example, for each iteration, the plurality of informative objects may be bounded by a predetermined quantity. As another example, the different sets of labeled training objects may differ in the weights assigned to the labeled objects. As another example, the different sets of labeled training objects may be generated via Bayesian bootstrapping or by using a Laplace approximation.

According to one aspect, a method includes generating, from a set of labeled objects, a plurality of training sets, each training set differing from the other training sets, assigning each of the plurality of training sets to a respective deep neural network in a committee of networks, and initializing each of the deep neural networks in the committee by training the deep neural network using the respective assigned training set. The method further includes iteratively training the deep neural networks in the committee until convergence and using one of the deep neural networks to make predictions for unlabeled objects. The training may be accomplished by identifying unlabeled objects with highest diversity in predictions from the plurality of deep neural networks, obtaining a respective label for each identified unlabeled object, and retraining the deep neural networks with the respective labels for the objects.

These and other aspects can include one or more of the following features. For example, generating the plurality of training sets can include generating the different sets of labeled training objects via Bayesian bootstrapping and/or using a Laplace approximation. As another example, the committee may include at least 100 deep neural networks. As another example, obtaining a respective label for an unlabeled object can include receiving a label from each of a plurality of human raters and aggregating the labels. As another example, generating the plurality of training sets includes randomized sub sampling of the set of labeled objects.

According to one aspect, a computer-readable medium stores a deep neural network. The deep neural network is trained by training a first deep neural network on a set of labeled training objects, initializing a committee of deep neural networks by sampling parameters from the first deep neural network based on a Gaussian distribution and a Fisher information matrix, iteratively training the deep neural networks of the committee until convergence and storing one of the deep neural networks on the computer readable medium. Iteratively training the deep neural networks of the committee may include identifying a plurality of informative objects, by providing unlabeled objects to the committee and selecting the unlabeled objects with highest diversity in the predictions of the deep neural networks in the committee, obtaining labels for the informative objects, and retraining the deep neural networks in the committee using the labels for the informative objects.

According to one aspect, a computer-readable medium stores a deep neural network trained by initializing a committee of deep neural networks using different sets of labeled training objects and iteratively training the committee of deep neural networks until convergence. Iteratively training the committee until convergence includes identifying a plurality of informative objects, by providing unlabeled objects to the committee and selecting the unlabeled objects with highest diversity in the predictions of the deep neural networks in the committee, obtaining labels for the informative objects, and retraining the committee of deep neural networks using the labels for the informative objects.

What is claimed is:

1. A method comprising:
providing an unlabeled object as input to each of a plurality of deep neural networks;
obtaining a plurality of predictions for the unlabeled object, each prediction being obtained from one of the plurality of deep neural networks;
determining whether the plurality of predictions satisfy a diversity metric; and
identifying the unlabeled object as an informative object when the predictions satisfy the diversity metric.

2. The method of claim 1, further comprising:
providing the informative object to a human rater;
receiving a label for the informative object from the human rater; and
retraining the plurality of deep neural networks using the label as a positive example for the informative object.

3. The method of claim 1, wherein the steps of providing, obtaining, determining, and identifying are iterated until convergence is reached.

4. The method of claim 3, wherein convergence is reached after a predetermined number of iterations.

5. The method of claim 3, wherein convergence is reached when diversity in the predictions of the deep neural networks fails to meet a diversity threshold.

6. The method of claim 3, wherein convergence is reached when no unlabeled objects have a plurality of predictions that satisfy the diversity metric.

7. The method of claim 1, further comprising:
initializing the plurality of deep neural networks using Bayesian bootstrapping.

8. The method of claim 1, further comprising:
initializing the plurality of deep neural networks using a Laplace approximation.

9. The method of claim 1, wherein determining whether the plurality of predictions satisfies the diversity metric includes using Bayesian Active Learning by Disagreement.

10. A computer-readable medium storing a deep neural network trained by:
initializing a committee of deep neural networks using different sets of labeled training objects;
iteratively training the deep neural networks of the committee until convergence by:
identifying a plurality of informative objects, by providing unlabeled objects to the committee and selecting the unlabeled objects with highest diversity in the predictions of the deep neural networks in the committee,
obtaining labels for the informative objects, and
retraining the deep neural networks in the committee using the labels for the informative objects; and
storing one of the deep neural networks on the computer readable medium.

11. The computer-readable medium of claim 10, wherein convergence is reached after a predetermined number of iterations.

12. The computer-readable medium of claim 10, wherein convergence is reached when diversity in the predictions of the deep neural networks fails to meet a diversity threshold.

13. The computer-readable medium of claim 10, wherein for each iteration the plurality of informative objects is bounded by a predetermined quantity.

14. The computer-readable medium of claim 10, wherein the different sets of labeled training objects differ in the weights assigned to the labeled objects.

15. The computer-readable medium of claim 10, wherein the different sets of labeled training objects are generated via Bayesian bootstrapping.

16. A method comprising:
generating, from a set of labeled objects, a plurality of training sets, each training set differing from the other training sets;
assigning each of the plurality of training sets to a respective deep neural network in a committee of networks;
initializing each of the deep neural networks in the committee by training the deep neural network using the respective assigned training set;
iteratively training the deep neural networks in the committee until convergence by:
identifying unlabeled objects with highest diversity in predictions from the plurality of deep neural networks,
obtaining a respective label for each identified unlabeled object, and
retraining the deep neural networks with the respective labels for the objects; and
using one of the deep neural networks to make predictions for unlabeled objects.

17. The method of claim 16, wherein generating the plurality of training sets includes generating the different sets of labeled training objects via Bayesian bootstrapping.

18. The method of claim 16 wherein the committee includes at least 100 deep neural networks.

19. The method of claim 16, wherein obtaining a respective label for an unlabeled object includes:
receiving a label from each of a plurality of human raters; and
aggregating the labels.

20. The method of claim 16, wherein generating the plurality of training sets includes randomized subsampling of the set of labeled objects.
